(19) United States
(12) Patent Application Publication
(10) Pub. No.: US 2006/0119268 A1
(43) Pub. Date: Jun. 8, 2006

(54) Plasma display panel and manufacturing method thereof

(75) Inventor: Yong Han Lee, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/288,338

(22) Filed: Nov. 29, 2005

(30) Foreign Application Priority Data
Dec. 8, 2004 (KR) 10-2004-0103268

(51) Int. Cl. H01J 17/49

(52) U.S. Cl. 313/582

(57) ABSTRACT

The present invention relates to a plasma display panel and method of manufacturing the same. In accordance with the present invention, in a process of forming a sealant on one of an upper substrate and a lower substrate from a first point to a second point, the sealant of the first point and the sealant of the second point are separated apart from each other, and the upper substrate and the lower substrate are then coalesced. Therefore, since an area where the sealants are overlapped with each other can be reduced, the sealants can be formed to have a uniform height. It is thus possible to completely seal the upper substrate and the lower substrate.

### CROSS-REFERENCES TO RELATED APPLICATIONS

This Nonprovisional application claims priority under 35 U.S.C. § 119(a) on Patent Application No. 2004-0103268 filed in Korea on Dec. 8, 2004 the entire contents of which are hereby incorporated by reference.

### BACKGROUND OF THE INVENTION

1. Field of the Invention

The present invention relates to a plasma display panel and method of manufacturing the same.

2. Background of the Related Art

A plasma display panel and a Liquid Crystal Device (LCD) are next-generation display devices having the highest practical use, of flat display devices. More particularly, the plasma display panel has a high luminance and a wide viewing angle in comparison with the LCD, and thus finds wide applications as large-screen displays. The plasma display panel displays images by emitting phosphors formed within each discharge cell.

FIG. 1 is a perspective view of a plasma display panel in the related art. As shown in FIG. 1, the plasma display panel in the related art comprises an upper substrate 100 and a lower substrate 200. The upper substrate 100 and the lower substrate 200 are combined with a predetermined distance therebetween.

Scan electrodes 111 and sustain electrodes 112 are formed in parallel on the upper substrate 100 and sustain emission by a discharge generated in one discharge cell. Each of the scan electrodes 111 comprises a transparent electrode 111a formed of a transparent Indium Thin Oxide (ITO) material and a bus electrode 111b formed of a metal material at the edge of the transparent electrode 111a. Each of the sustain electrodes 112 comprises a transparent electrode 112a formed of an ITO material and a bus electrode 112b formed of a metal material at the edge of the transparent electrode 112a.

An upper dielectric layer 120 provides insulation between the scan electrodes 111 and the sustain electrodes 112 and forms wall charges. A protection layer 130 is formed by depositing Magnesium Oxide (MgO). The protection layer 130 protects the scan electrodes 111 and the sustain electrodes 112 from collision against ions during the discharge of plasma and facilitates the emission of secondary electrons.

Address electrodes 222 are formed on the lower substrate 200 to cross the scan electrodes 111 and the sustain electrodes 112, and perform an address discharge. A lower dielectric layer 230 is formed on the address electrodes 220 and provides insulation between the address electrodes 220.

Barrier ribs 210 are formed on the lower dielectric layer 230 and are arranged in parallel in order to form discharge cells. The barrier ribs 210 shields electrical and optical interference between the discharge cells and support the upper substrate 100 and the lower substrates 100, 200.

Red, green and blue phosphor layers 240 are formed between the barrier ribs 210 and emit a visible ray for displaying images during the address discharge.

The upper substrate 100 and the lower substrate 200 are coalesced by a sealant in a sealing process in order to maintain vacuum within the substrates, and then experience an exhaust process for removing impurities within the panel.

After the exhaust process is finished, an inert gas, such as helium (He), neon (Ne) or xeon (Xe), is injected into the plasma display panel in order to increase discharge efficiency during the discharge of plasma.

In the plasma display panel of the related art, after a discharge cell is selected by the address discharge generating between the address electrodes 220 and the scan electrodes 111, a consecutive display discharge is generated in the selected discharge cell by a sustain discharge generated between the scan electrodes 111 and the sustain electrodes 112. That is, electrons existing within the discharge cell collide against the inert gas filled in the discharge cell while being accelerated by a driving voltage applied thereto, and are then excited by the inert gas to generate ultraviolet ray. If the ultraviolet ray collide against the phosphors 240 surrounding the address electrodes 220 and the barrier ribs 210, a visible ray is radiated from the phosphors 240, thus displaying image.

In the coalescence process for coalescing the upper substrate 100 and the lower substrate 200, however, a sealant layer is formed using a sealant paste. The sealant layer can be formed by a screen-printing method, a dispenser method or the like.

The screen-printing method can be performed using simple production equipment and has high material reuse efficiency. Therefore, this method has been used a lot in the fabrication of the plasma display panel. The screen-printing method is a method of printing a desired shape on a glass substrate by allowing a sealant paste compressed by squeeze to pass through a patterned screen.

The dispenser method can obviate mask fabrication expenses and can easily form a thick film. The dispenser method is a technique of forming a desired shape on the glass substrate by directly discharging the sealant paste on the glass substrate using air pressure.

The sealant layer can be formed using a variety of methods as well as the screen-printing method or the dispenser method.

In the coalescence process of the upper substrate 100 and the lower substrate 200, the shape of the sealant paste that is printed or coated by a variety of methods such as the screen-printing method or the dispenser method is a closed curve. That is, the sealant is formed from a first point to a second point along the outline of the lower substrate 200. The sealant of the second point and the sealant of the first point are overlapped with each other. As the sealant at the second point and the sealant at the first point are overlapped with each other, the height of the overlapped sealant is greater than the height of a non-overlapped sealant.

FIG. 2a shows the shape of a sealant for adhering the upper substrate and the lower substrate of the plasma display panel in the related art. FIG. 2b is a cross-sectional view of the sealant taken along lines A-A′ in FIG. 2a. As shown in FIGS. 2a and 2b, a sealant 300 is printed or coated on the lower substrate 200. As the sealant 300 near the first point is overlapped with the sealant 300 of the second point, the height of the overlapped sealant is greater than the height of a non-overlapped sealant. Therefore, when the upper substrate 100 and the lower substrate 200 are coalesced, the upper substrate 100 and the lower substrate 200 are not parallel to each other due to a difference between the height of an overlapped sealant and the height of a non-overlapped sealant. Since the upper substrate 100 and the lower substrate 200 are not coalesced in parallel, a problem arises because sealing between the upper substrate 100 and the lower substrate 200 is not complete.

Furthermore, in the sintering process of the sealant 300, when the sealant 300 is melt, a difference between the height of an overlapped sealant and the height of a non-overlapped sealant hinders force by coalescence from being equally distributed into the upper substrate 100 or the lower substrate 200. This worsens an align offset of the upper substrate 100 and the lower substrate 200.

### SUMMARY OF THE INVENTION

Accordingly, an object of the present invention is to solve at least the problems and disadvantages of the background art.

It is an object of the present invention to provide a plasma display panel and method of manufacturing the same, in which an area where sealants are overlapped with each other can be reduced.

A method of manufacturing a plasma display panel according to an aspect of the present invention comprises the step of preparing an upper substrate and a lower substrate of the plasma display panel in a process of forming a sealant on one of the upper substrate and the lower substrate from a first point to a second point, separating the sealant of the first point and the sealant of the second point apart from each other, and coalescing the upper substrate and the lower substrate.

A plasma display panel according to another aspect of the present invention comprises an upper substrate, a lower substrate, and a sealant coalescing the upper substrate and the lower substrate, wherein a part of the sealant formed at a first point and a part of the sealant formed at a second point are overlapped with each other.

A plasma display panel according to further another aspect of the present invention comprises an upper substrate, a lower substrate, and a sealant coalescing the upper substrate and the lower substrate, wherein a width of a part of the sealant is wider than the width of the other part of the sealant.

According to the present invention, since an area where sealants are overlapped with each other is reduced, the sealants can be formed to have a uniform height. Therefore, an upper substrate and a lower substrate can be sealed completely.

### BRIEF DESCRIPTION OF THE DRAWINGS

The invention will be described in detail with reference to the following drawings in which like numerals refer to like elements.

FIG. 1 is a perspective view of a plasma display panel in the related art;

FIG. 2a shows the shape of a sealant for coalescing an upper substrate and a lower substrate of the plasma display panel in the related art;

FIG. 2b is a cross-sectional view of the sealant taken along lines A-A′ in FIG. 2a;

FIG. 3a shows the shape of a sealant for coalescing an upper substrate and a lower substrate according to a first embodiment of the present invention;

FIG. 3b is a partial exaggerated view of the sealant shown in FIG. 3a;

FIG. 4 shows the shape of the sealant after the upper substrate and the lower substrate are coalesced;

FIG. 5 is a cross-sectional view of the sealant taken along lines B-B′ in FIG. 4;

FIG. 6 shows the shape of a sealant for coalescing an upper substrate and a lower substrate according to a second embodiment of the present invention;

FIG. 7 shows the shape of a sealant for coalescing an upper substrate and a lower substrate according to a third embodiment of the present invention;

FIG. 8 shows the shape of a sealant for coalescing an upper substrate and a lower substrate according to a fourth embodiment of the present invention; and

FIG. 9 is a flowchart illustrating a method of manufacturing a plasma display panel according to an embodiment of the present invention.

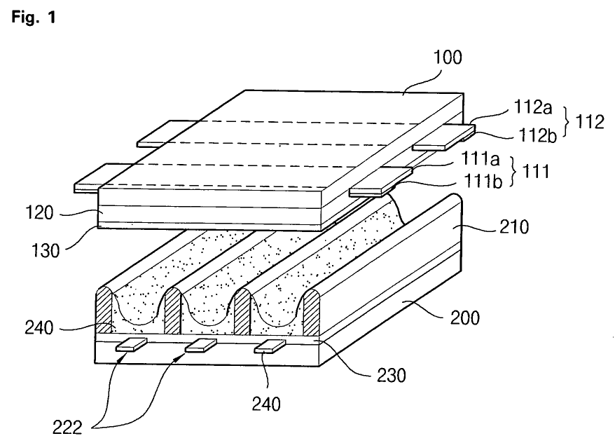

### DETAILED DESCRIPTION OF THE PREFERRED EMBODIMENT

Preferred embodiments of the present invention will be described in a more detailed manner with reference to the drawings.

A method of manufacturing a plasma display panel according to an aspect of the present invention comprises the step of preparing an upper substrate and a lower substrate of the plasma display panel in a process of forming a sealant on one of the upper substrate and the lower substrate from a first point to a second point, separating the sealant of the first point and the sealant of the second point apart from each other, and coalescing the upper substrate and the lower substrate.

A distance between the sealant of the first point and the sealant of the second point may be equal to or more than 0.5 mm to less than or equal to 2 mm.

The sealant may be formed on the one of the upper substrate and the lower substrate by either a dispenser method or a screen-printing method.

The sealant may be frit glass.

The sealant of the second point may be bent toward the center of the one of the upper substrate and the lower substrate.

The sealant of the first point may be bent toward the center of the one of the upper substrate and the lower substrate.

A distance between the sealant of the second point and the center of the one of the upper substrate and the lower substrate may be smaller than a distance between the sealant of the first point and the center of the one of the upper substrate and the lower substrate.

A distance between the sealant of the second point and the center of the one of the upper substrate and the lower substrate may be greater than a distance between the sealant of the first point and the center of the one of the upper substrate and the lower substrate.

The sealant of the second point may be bent toward the center of the one of the upper substrate and the lower substrate, and the sealant of the first point may be bent in a direction opposite to a center direction of the one of the upper substrate and the lower substrate.

The sealant of the first point may be bent toward the center of the one of the upper substrate and the lower substrate and the sealant of the second point may be bent in a direction opposite to a center direction of the one of the upper substrate and the lower substrate.

The sealant of the first point and the sealant of the second point may be separated apart from each other at a predetermined distance and located on a straight line.

A plasma display panel according to another aspect of the present invention comprises an upper substrate, a lower substrate, and a sealant coalescing the upper substrate and the lower substrate, wherein a part of the sealant formed at a first point and a part of a sealant formed at a second point are overlapped with each other.

The sealant may be formed by either a dispenser method or a screen-printing method.

The sealant may be frit glass.

A plasma display panel according to further another aspect of the present invention comprises an upper substrate, a lower substrate, and a sealant coalescing the upper substrate and the lower substrate, wherein a width of a part of the sealant is wider than the width of the other portions of the sealant.

The width of the part of the sealant may be equal to or more than 1.5 times to less than or equal to 2 times of the width of the other portions of the sealant.

The sealant may be formed by either a dispenser method or a screen-printing method.

The sealant may be frit glass.

Hereinafter, detailed embodiments of the present invention will be described with reference to the accompanying drawings.

### Embodiment 1

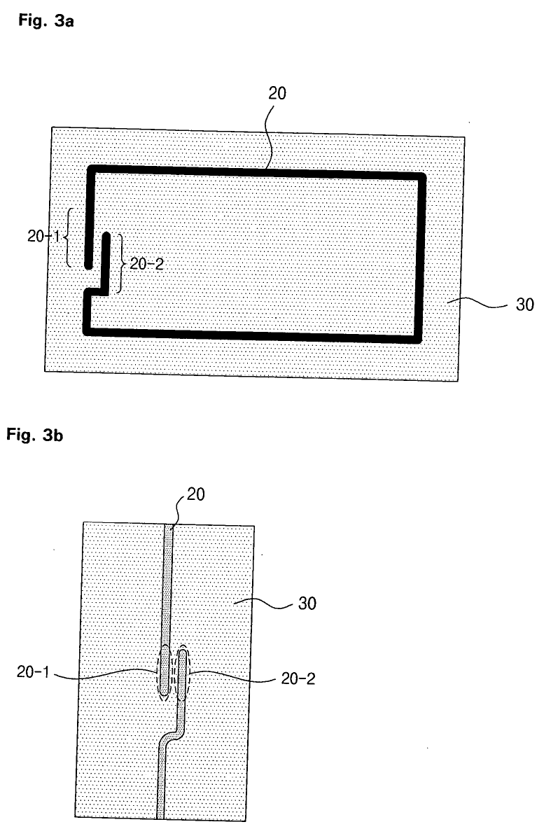

FIG. 3a shows the shape of a sealant for adhering an upper substrate and a lower substrate according to a first embodiment of the present invention. FIG. 3b is a partial exaggerated view of the sealant shown in FIG. 3a.

As shown in FIG. 3a or FIG. 3b, a sealant 20 for coalescence with an upper substrate is printed or coated on a lower substrate 30 from a first point to a second point along the outline of the lower substrate 30 by means of the screen-printing method or the dispenser method. The sealant 20 can be formed by other methods as well as the screen-printing method or the dispenser method. A sealant 20-1 of the first point is separated apart from a sealant 20-2 of the second point at a predetermined distance. That is, the sealant 20-2 of the second point is bent toward the center of the lower substrate 30, so that the sealant 20-2 of the second point is separated apart from the sealant 20-1 of the first point at a predetermined distance. Furthermore, the sealant 20-1 of the first point is bent toward the center of the lower substrate 30, so that the sealant 20-1 of the first point can be separated apart from the sealant 20-2 of the second point at a predetermined distance.

Though not shown in FIGS. 3a and 3b, before the sealants are formed, address electrodes for an address discharge, a lower dielectric layer that provides insulation between the address electrodes, barrier ribs for forming discharge cells, and phosphor layers for generating light are formed on the lower substrate 30.

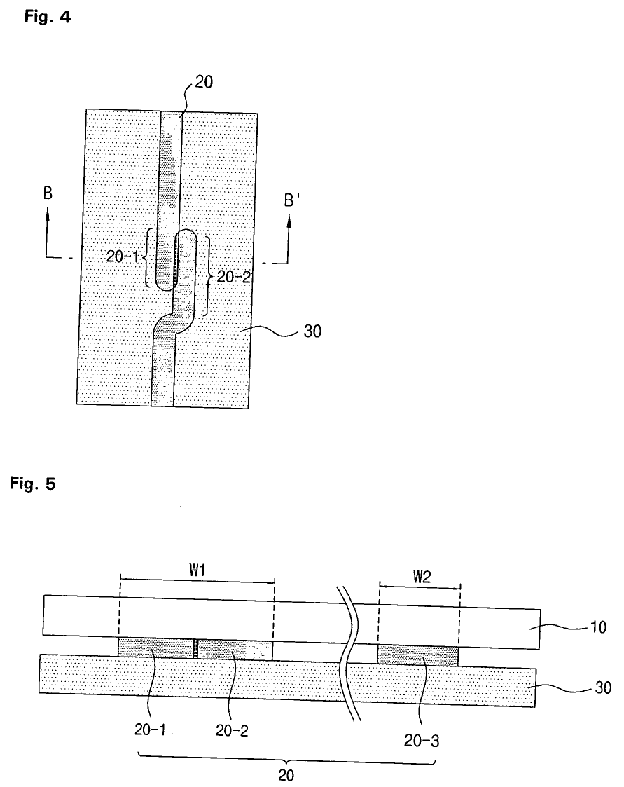

FIG. 4 shows the shape of the sealant after the upper substrate and the lower substrate are adhered. As shown in FIG. 4, the sealant 20-1 of the first point is separated apart from the sealant 20-2 of the second point at a predetermined distance. Therefore, when the lower substrate 30 and an upper substrate (not shown) are coalesced, the sealant 20-1 of the first point and the sealant 20-2 of the second point fill the predetermined distance while spreading. That is, when the sealant 20 is formed on the lower substrate 30 before the lower substrate 30 and the upper substrate are coalesced, the shape of the sealant 20 is not a closed curve due to the predetermined distance between the sealant 20-1 of the first point and the sealant 20-2 of the second point. If the lower substrate 30 and the upper substrate are coalesced, however, the sealant 20-1 of the first point and the sealant 20-2 of the second point spread and fill the predetermined distance while a part of the sealant 20-1 of the first point and a part of the sealant 20-2 of the second point are overlapped with other. After the coalescence, a plasma display panel consisting of the lower substrate 30 and the upper substrate is tightly sealed. Therefore, a total width (W1) of the sealants at the portion where the sealant 20-1 of the first point and the sealant 20-2 of the second point is wider than a width (W2) of the sealants at other portions. That is, the total width (W1) of the sealants at the portion where the sealant 20-1 of the first point and the sealant 20-2 of the second point is equal to or more than 1.5 to less than or equal to 2 times of the width of the other part of the sealant.

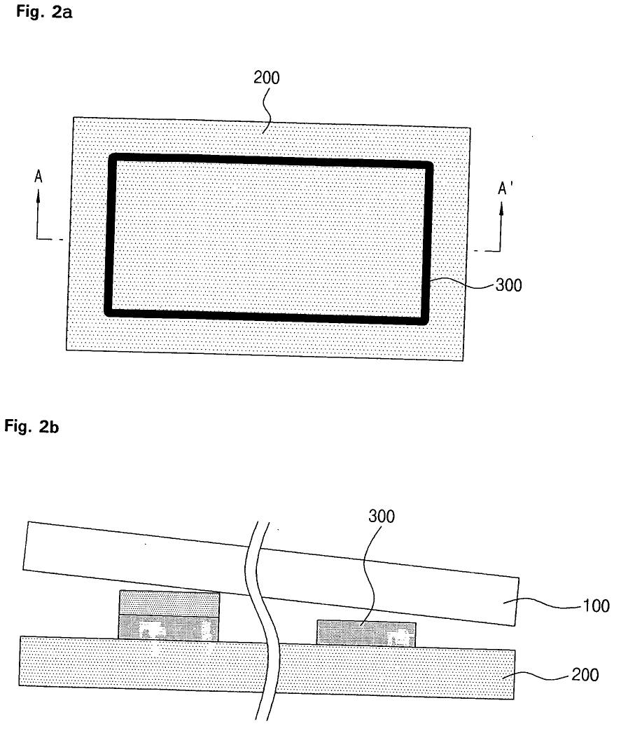

As shown in FIG. 2, in the plasma display panel of the related art, after the sealant of the first point and the sealant of the second point are overlapped, a difference between the height of the sealant at the overlapping region to which a coalescence process is performed and the height of the sealant at non-overlapping regions is increased. To the contrary, as shown in FIG. 4, in the plasma display panel of the present invention, after the sealant 20-1 of the first point and the sealant 20-2 of the second point are separated apart from each other at a predetermined distance, a region to which the coalescence process is performed becomes small, so that the height of the sealant in the entire regions where the sealant 20 is formed is almost similar.

According to a first embodiment of the present invention, before the lower substrate and the upper substrate are coalesced, the predetermined distance between the sealant 20-1 of the first point and the sealant 20-2 of the second point can be equal to or more than 0.5 mm to less than or equal to 2 mm in order for sealing to be completely performed after the upper substrate and the lower substrate are coalesced.

In the first embodiment of the present invention, it has been described that the sealant 20 is formed in the lower substrate 30. However, the sealant 20 can be formed in the upper substrate.

FIG. 5 is a cross-sectional view of the sealant taken along lines B-B′ in FIG. 4. Before the upper substrate 10 and the lower substrate 30 are coalesced as shown in FIG. 3a, the sealant 20-1 of the first point and the sealant 20-2 of the second point are separated apart from each other at a predetermined distance. Thereafter, if the upper substrate 10 and the lower substrate 30 are coalesced, the sealant 20-1 of the first point and the sealant 20-2 of the second point bury the predetermined distance, while spreading, by way of pressure applied to the upper substrate 10 and the lower substrate 30 during the coalescence process as shown in FIG. 5. Therefore, the height of the sealant 20-1 of the first point and the sealant 20-2 of the second point is almost the same as the height of the sealant 20-3 formed in other regions. The upper substrate 10 and the lower substrate 30 are coalesced in parallel. Furthermore, if the sealant 20 is melt in a sintering process, pressure is evenly distributed over the upper substrate 10 or the lower substrate 30 when the upper substrate 10 and the lower substrate 30 are coalesced because the height between the upper substrate 10 and the lower substrate 30 is constant.

### Embodiment 2

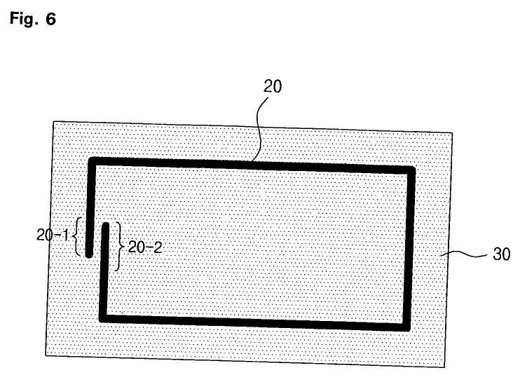

FIG. 6 shows the shape of a sealant for adhering an upper substrate and a lower substrate according to a second embodiment of the present invention. As shown in FIG. 6, a sealant 20-1 of a first point is separated apart from a sealant 20-2 of a second point at a predetermined distance. That is, the sealant 20-2 of the second point, which is close to the center of a lower substrate 30, is separated apart from the sealant 20-1 of the first point at a predetermined distance. A distance between the sealant 20-1 of the first point and the center of the lower substrate 30 can be greater than the distance between the sealant 20-2 of the second point and the center of the lower substrate 30. Furthermore, a distance between the sealant 20-1 of the first point and the center of the lower substrate 30 can be smaller than the distance between the sealant 20-2 of the second point and the center of the lower substrate 30.

In the above two cases, the sealant 20-2 of the second point is separated apart from the sealant 20-1 of the first point at a predetermined distance.

In the coalescence process of the upper substrate and the lower substrate, the sealant 20-1 of the first point and the sealant 20-2 of the second point bury the predetermined distance while spreading, so that coalescence is performed.

In accordance with a second embodiment of the present invention, before the lower substrate and the upper substrate are coalesced, the predetermined distance between the sealant 20-1 of the first point and the sealant 20-2 of the second point can be equal to or more than 0.5 mm to less than or equal to 2 mm in order for sealing to be completely performed after the upper substrate and the lower substrate are coalesced.

In the second embodiment of the present invention, it has been described that the sealant 20 is formed in the lower substrate 30. However, the sealant 20 can be formed in the upper substrate.

### Embodiment 3

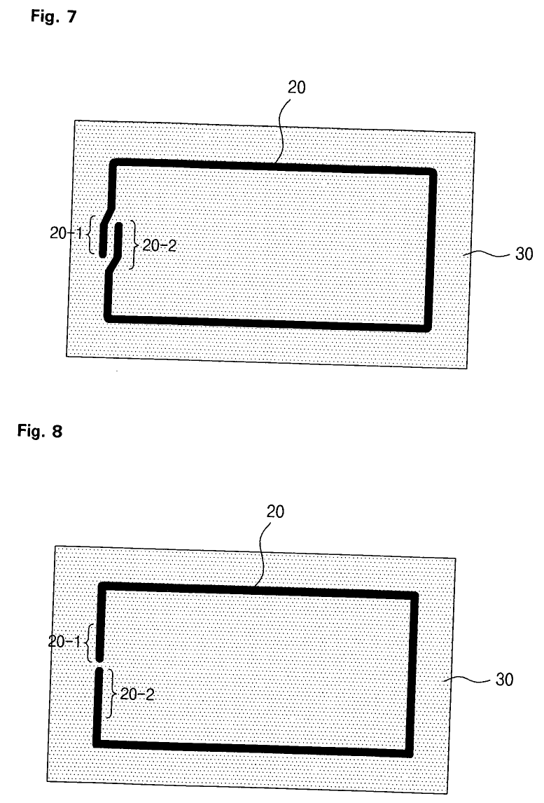

FIG. 7 shows the shape of a sealant for adhering an upper substrate and a lower substrate according to a third embodiment of the present invention. As shown in FIG. 7, a sealant 20-1 of a first point is separated apart from a sealant 20-2 of a second point at a predetermined distance. That is, the sealant 20-2 of the second point is bent toward the center of a lower substrate 30 and the sealant 20-1 of the first point is bent in a direction opposite to a center direction of the lower substrate 30. Therefore, the sealant 20-2 of the second point is separated apart from the sealant 20-1 of the first point at a predetermined distance.

Furthermore, the sealant 20-1 of the first point is bent toward the center of the lower substrate 30 and the sealant 20-2 of the second point is bent in a direction opposite to a center direction of the lower substrate 30. Therefore, the sealant 20-1 of the first point and the sealant 20-2 of the second point can be separated apart from each other at a predetermined distance.

In a coalescence process of the upper substrate and the lower substrate, the sealant 20-1 of the first point and the sealant 20-2 of the second point bury the predetermined distance while spreading, so that coalescence is performed.

In accordance with the third embodiment of the present invention, before the lower substrate and the upper substrate are coalesced, the predetermined distance between the sealant 20-1 of the first point and the sealant 20-2 of the second point can be equal to or more than 0.5 mm to less than or equal to 2 mm in order for sealing to be completely performed after the upper substrate and the lower substrate are coalesced.

In the third embodiment of the present invention, it has been described that the sealant 20 is formed in the lower substrate 30. However, the sealant 20 can be formed in the upper substrate.

### Embodiment 4

FIG. 8 shows the shape of a sealant for adhering an upper substrate and a lower substrate according to a fourth embodiment of the present invention. As shown in FIG. 8, a sealant 20-1 of a first point is separated apart from a sealant 20-2 of a second point at a predetermined distance. That is, the sealant 20-1 of the first point and the sealant 20-2 of the second point are located on a straight line with them being separated apart from each other a predetermined distance. In a coalescence process of an upper substrate and a lower substrate, the sealant 20-1 of the first point and the sealant 20-2 of the second point bury the predetermined distance while spreading, so that coalescence is performed.

In a fourth embodiment of the present invention, it has been described that the sealant 20 is formed in the lower substrate 30. However, the sealant 20 can be formed in the upper substrate.

The sealant 20 used in the first to fourth embodiments of the present invention can be frit glass.

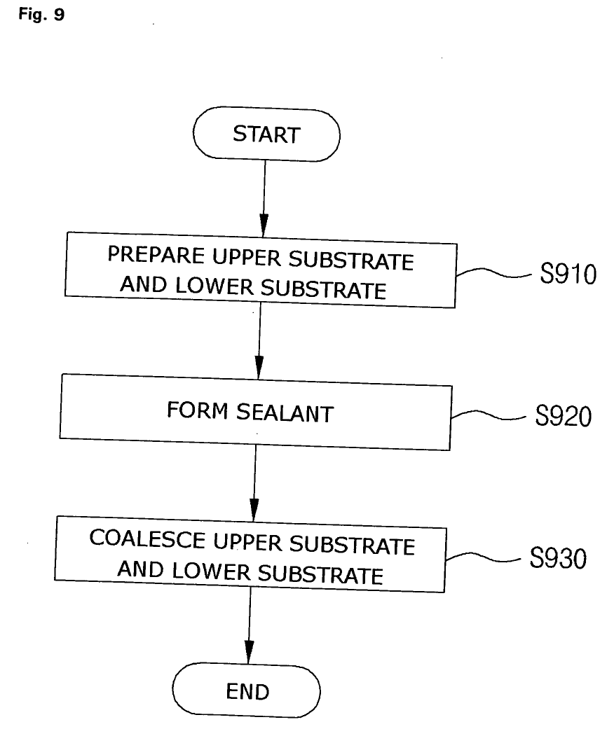

FIG. 9 is a flowchart illustrating a method of manufacturing a plasma display panel according to an embodiment of the present invention. An upper substrate and a lower substrate of a plasma display panel at step S910. Scan electrodes and sustain electrodes for an address discharge and a sustain discharge, an upper dielectric layer that provides insulation between the scan electrodes and the sustain electrodes, and a protection layer for protecting the scan electrodes and the sustain electrodes are formed on the upper substrate. Address electrodes for an address discharge, a lower dielectric layer that provides insulation between the address electrodes, barrier ribs for forming discharge cells, and a phosphor layer for emitting a visible ray are formed on the lower substrate. An upper substrate and a lower substrate having other structure can be prepared.

In a process of forming a sealant on any one of the upper substrate and the lower substrate from a first point to a second point, the sealant of the first point and the sealant of the second point are separated apart from each other at a predetermined distance at step S920. At step S920, the shape of the sealant can have the same shape as those described with reference to the first to fourth embodiments. The predetermined distance can be equal to or more than 0.5 mm to less than or equal to 2 mm. The sealant is formed on the substrate by means of either the screen-printing method or the dispenser method. The sealant 20 can also be formed by methods other than the screen-printing method or the dispenser method. Furthermore, the sealant can be frit glass.

Thereafter, the upper substrate and the lower substrate are coalesced by the sealant at step S930. In the coalescence process, the sealant of the first point and the sealant of the second point, which are separated apart from each other, bury the predetermined distance, while spreading, so that coalescence is performed.

The invention being thus described, it will be obvious that the same may be varied in many ways. Such variations are not to be regarded as a departure from the spirit and scope of the invention, and all such modifications as would be obvious to one skilled in the art are intended to be comprised within the scope of the following claims.

What is claimed is:

1. A method of manufacturing a plasma display panel, the method comprising the steps of:
preparing an upper substrate and a lower substrate of the plasma display panel;
separating a sealant of a first point and the sealant of a second point apart from each other in a process of forming the sealant on one of the upper substrate and the lower substrate from the first point to the second point; and
coalescing the upper substrate and the lower substrate.

2. The method as claimed in claim 1, wherein a distance between the sealant of the first point and the sealant of the second point is equal to or more than 0.5 mm to less than or equal to 2 mm.

3. The method as claimed in claim 1, wherein the sealant is formed on the one of the upper substrate and the lower substrate by either a dispenser method or a screen-printing method.

4. The method as claimed in claim 1, wherein the sealant is frit glass.

5. The method as claimed in claim 1, wherein the sealant of the second point is bent toward the center of the one of the upper substrate and the lower substrate.

6. The method as claimed in claim 1, wherein the sealant of the first point is bent toward the center of the one of the upper substrate and the lower substrate.

7. The method as claimed in claim 1, wherein a distance between the sealant of the second point and the center of the one of the upper substrate and the lower substrate is smaller than a distance between the sealant of the first point and the center of the one of the upper substrate and the lower substrate.

8. The method as claimed in claim 1, wherein a distance between the sealant of the second point and the center of the one of the upper substrate and the lower substrate is greater than a distance between the sealant of the first point and the center of the one of the upper substrate and the lower substrate.

9. The method as claimed in claim 1, wherein the sealant of the second point is bent toward the center of the one of the upper substrate and the lower substrate, and the sealant of the first point is bent in a direction opposite to a center direction of the one of the upper substrate and the lower substrate.

10. The method as claimed in claim 1, wherein the sealant of the first point is bent toward the center of the one of the upper substrate and the lower substrate and the sealant of the second point is bent in a direction opposite to a center direction of the one of the upper substrate and the lower substrate.

11. The method as claimed in claim 1, wherein the sealant of the first point and the sealant of the second point are separated apart from each other at a predetermined distance, and are located on a straight line.

12. A plasma display panel comprising:
an upper substrate;
a lower substrate; and
a sealant coalescing the upper substrate and the lower substrate,
wherein a part of the sealant formed at a first point and a part of the sealant formed at a second point are overlapped with each other.

13. The plasma display panel as claimed in claim 12, wherein the sealant is formed by either a dispenser method or a screen-printing method.

14. The plasma display panel as claimed in claim 12, wherein the sealant is frit glass.

15. A plasma display panel comprising:
an upper substrate;
a lower substrate; and
a sealant coalescing the upper substrate and the lower substrate,
wherein a width of a part of the sealant is wider than the width of the other part of the sealant.

16. The plasma display panel as claimed in claim 15, wherein the width of the part of the sealant is equal to or more than 1.5 times to less than or equal to 2 times of the width of the other part of the sealant.

17. The plasma display panel as claimed in claim 15, wherein the sealant is formed by either a dispenser method or a screen-printing method.

18. The plasma display panel as claimed in claim 15, wherein the sealant is frit glass.
